(19) United States
(12) Patent Application Publication
(10) Pub. No.: US 2008/0111926 A1
(43) Pub. Date: May 15, 2008

(54) PROJECTION SYSTEM AND ADJUSTING METHOD THEREOF

(75) Inventor: Chun-Li Chen, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CORETRONIC CORPORATION, Hsinchu (TW)

(21) Appl. No.: 11/845,104

(22) Filed: Aug. 27, 2007

(30) Foreign Application Priority Data
Nov. 10, 2006 (TW) 95141637

(51) Int. Cl. H04N 9/31

(52) U.S. Cl. 348/744; 348/E09.012; 348/E09.025

(57) ABSTRACT

A projection system includes a first projection apparatus, a second projection apparatus, a sensing element, and a processing unit. The first projection apparatus is used for projecting a first frame on a screen. The second projection apparatus is used for projecting a second frame on the screen. The sensing element is used for sensing the first frame and the second frame on the screen and generating a first signal corresponding to the first frame and a second signal corresponding to the second frame. The processing unit is electrically connected to the first projection apparatus, the second projection apparatus and the sensing element. The processing unit is used for receiving the first signal and the second signal and controlling the second projection apparatus according to the first signal and the second signal to overlap the second frame on the first frame on the screen.

### CROSS-REFERENCE TO RELATED APPLICATION

This application claims the priority benefit of Taiwan application serial no. 95141637, filed Nov. 10, 2006. All disclosure of the Taiwan application is incorporated herein by reference.

### BACKGROUND OF THE INVENTION

1. Field of the Invention

The present invention relates to a display apparatus, and more particularly, to a projection system with a plurality of projection apparatuses and an adjusting method thereof.

2 . Description of Related Art

FIG. 1 is a schematic view of a conventional projection system, and FIG. 2 is a schematic view of the imaging of the conventional projection system. Referring to FIGS. 1 and 2, the conventional projection system 10 comprises a projection apparatus 20 and a projection apparatus 30. The projection system 10 enables frames projected by the projection apparatus 20 and the projection apparatus 30 to overlap, so as to increase the brightness of the frame. More particularly, the projection apparatus 20 and the projection apparatus 30 respectively project a frame 50 and a frame 60 on a screen 40. The frame 50 and the frame 60 may partially overlap (for example, as indicated by the region 70 with oblique lines in FIG. 2). Next, an image processing chip in the projection system 10 is used to make both the projection apparatus 20 and the projection apparatus 30 project the frames in the region 70, and the images of the two frames projected in the region 70 are the same, thereby the two frames overlap, so as to enhance the brightness of the frame.

However, since the size of the overlapped frame is significantly smaller than the size of the frame projected by a single projection apparatus, the resolution of the projection system 10 is lower than that of the single projection apparatus. Moreover, in order to make the size of the overlapped frame be the same as that of the frame projected by the single projection apparatus, the overlapped frame must be enlarged, such that the quality of the frame is adversely affected. In addition, the image processing operation is complex, such that a high cost image processing chip must be used to perform the image processing, thereby the production cost of the projection system 10 is increased.

### SUMMARY OF THE INVENTION

The present invention is directed to a projection system capable of making frames projected by different projection apparatuses to overlap, and making the size of the overlapped frames be the same as the maximum size of frames projected by a single projection apparatus.

The present invention is also directed to a method of adjusting a projection system, so as to make frames projected by different projection apparatuses overlap, and to make the size of the overlapped frames be the same as the maximum size of frames projected by a single projection apparatus.

As embodied and broadly described herein, the present invention provides a projection system, which comprises a first projection apparatus, a second projection apparatus, a sensing element and a processing unit. The first projection apparatus is used for projecting a first frame on a screen. The second projection apparatus is used for projecting a second frame on the screen. The sensing element is used for sensing the first frame and the second frame on the screen to generate a first signal corresponding to the first frame and a second signal corresponding to the second frame. The processing unit is electrically connected to the first projection apparatus, the second projection apparatus and the sensing element, wherein the processing unit is used for receiving the first signal and the second signal, and for controlling the second projection apparatus according to the first signal and the second signal, so as to overlap the second frame on the first frame on the screen.

As embodied and broadly described herein, the present invention provides a method of adjusting a projection system, which is used for adjusting a projection system. The method of adjusting the projection system comprises the following steps. (a) A first projection apparatus projects a first frame on a screen. (b) A sensing element senses the first frame and generates a first signal corresponding to the first frame, and a processing unit records the first signal. (c) A second projection apparatus projects a second frame on the screen. (d) The sensing element senses the second frame and generates a second signal corresponding to the second frame, and the processing unit records the second signal. (e) The processing unit controls the second projection apparatus according to the first signal and the second signal to overlap the second frame on the first frame on the screen.

In the present invention, the processing unit adjusts the position of the frame projected by the projection apparatus according to the sensing result of the sensing element, so as to overlap the frames projected by a plurality of projection apparatuses. Therefore, the projection system of the present invention makes the size of the overlapped frame be the same as the maximum size of the frame projected by the single projection apparatus, so as to avoid inaccuracy and inconvenience for the manual adjustment.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a conventional projection system.

FIG. 2 is a schematic view of the imaging of the conventional projection system.

FIG. 3 is a schematic view of a projection system according to a first embodiment of the present invention.

FIG. 4A is a schematic view of the imaging of the projection system of FIG. 3 before being adjusted.

FIG. 4B is a schematic view of the imaging of the projection system of FIG. 3 after being adjusted.

FIG. 5 is a flow chart of a method of adjusting the projection system of FIG. 3.

FIG. 6 is a schematic view of a projection system according to a second embodiment of the present invention.

FIG. 7A is a schematic view of the imaging of the projection system of FIG. 6 before being adjusted.

FIG. 7B is a schematic view of the imaging of the projection system of FIG. 6 after being adjusted.

FIG. 8 is a flow chart of the method of adjusting the projection system of FIG. 3.

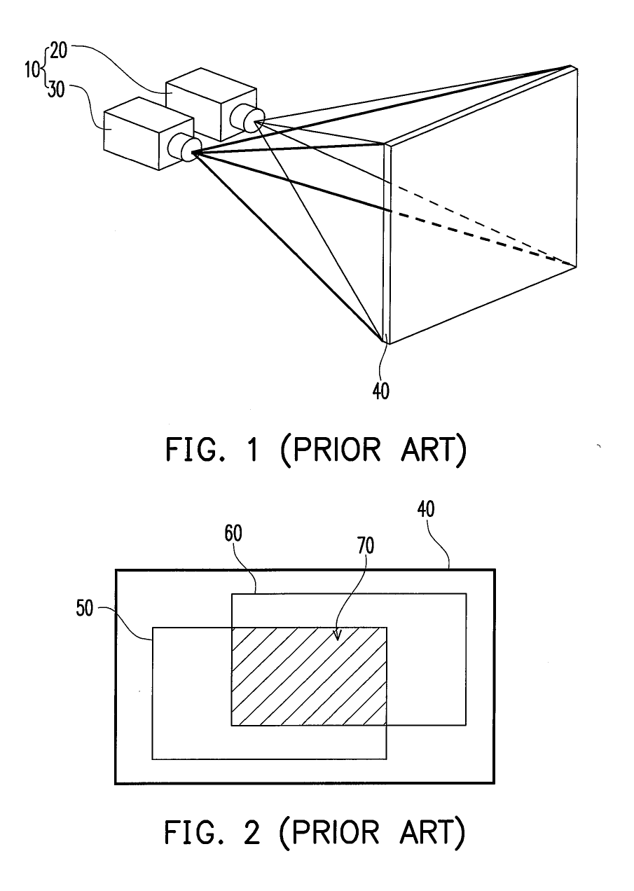

### DESCRIPTION OF EMBODIMENTS

It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and “coupled,” and variations thereof herein are used broadly and encompass direct and indirect connections, couplings, and mountings.

### First Embodiment

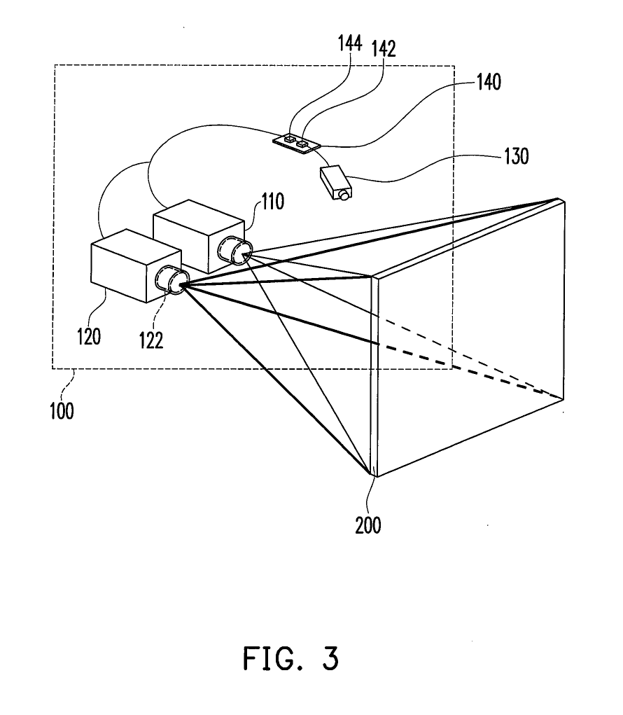

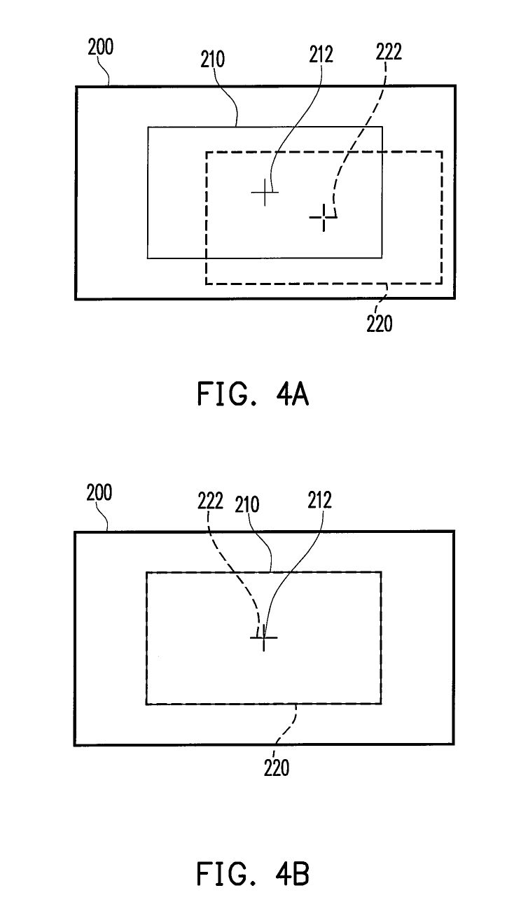

FIG. 3 is a schematic view of a projection system according to a first embodiment of the present invention, FIG. 4A is a schematic view of the imaging of the projection system of FIG. 3 before being adjusted, and FIG. 4B is a schematic view of the imaging of the projection system of FIG. 3 after being adjusted. Referring to FIGS. 3, 4A, and 4B, a projection system 100 includes a first projection apparatus 110, a second projection apparatus 120, a sensing element 130 and a processing unit 140. The processing unit 140 is electrically connected to the first projection apparatus 110, the second projection apparatus 120 and the sensing element 130. In addition, the first projection apparatus 110 is used for projecting a first frame 210 on a screen 200, and the second projection apparatus 120 is used for projecting a second frame 220 on the screen 200 (shown in FIG. 4A). The sensing element 130 is used for sensing the first frame 210 and the second frame 220 on the screen 200, so as to generate a first signal corresponding to the first frame 210 and a second signal corresponding to the second frame 220. The processing unit 140 is used for receiving the first signal and the second signal, and for controlling the second projection apparatus 120 according to the first signal and the second signal, so as to overlap the second frame 220 on the first frame 210 on the screen 200 (shown in FIG. 4B).

In this embodiment, the processing unit 140 includes an address controller 142 and a signal processor 144 electrically connected to the address controller 142. In addition, the second projection apparatus 120 has a movable projection lens 122 and a driving module (not shown) for driving the movable projection lens 122. The address controller 142 is used to record the first signal and the second signal, and compare an address data of the first signal with an address data of the second signal. The signal processor 144 controls the second projection apparatus 120 according to the comparison result obtained by the address controller 142. More particularly, the signal processor 144 controls the driving module according to the comparing result obtained by the address controller 142, so as to adjust a focal length and position of the movable projection lens 122, thereby making the second frame 220 overlap the first frame 210 on the screen 200.

The sensing element 130 is, for example, a charge-coupled device (CCD) or a complementary metal-oxide semiconductor (CMOS) image sensor. In this embodiment, the processing unit 140 is an independent apparatus, but those skilled in the art may employ the processing unit 140 within the first projection apparatus 110 or the second projection apparatus 120, or integrate the sensing element 130 within the same housing. In addition, the projection system 100 can further includes a fixing apparatus (not shown), and both the first projection apparatus 110 and the second projection apparatus 120 are fixed by the fixing apparatus, such that the relative position between the first projection apparatus 110 and the second projection apparatus 120 are maintained to be constant.

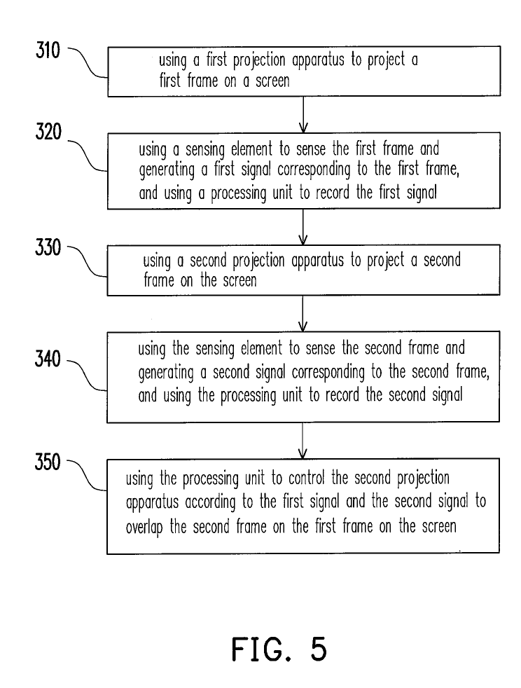

A method of adjusting the projection system 100 is described as follows. Referring to FIGS. 3 to 5, FIG. 5 is a flow chart of a method of adjusting the projection system of FIG. 3. The method of adjusting the projection system 100 in this embodiment includes the following steps. First, as shown in step 310, the first projection apparatus 110 projects the first frame 210 on the screen 200. The first frame 210 has a first image 212, for example, a cross-shaped pattern in the right center of the first frame 210. The first image 212 may be used as a reference for adjusting the first frame 210.

Next, as shown in step 320, the sensing element 130 senses the first frame 210 and generates a first signal corresponding to the first frame 210, and the processing unit 140 records the first signal. The first signal is recorded, for example, by way of using the address controller 142 to record the first signal, and the first signal includes the address data of the first frame 210 on the screen 200.

Next, as shown in step 330, the second projection apparatus 120 projects the second frame 220 on the screen 200. The second frame 220 has a second image 222, which is, for example, the same as the first image 212 and located in the right center of the second frame 220. The second image 222 is compared with the first image 212 to determine whether or not the first frame 210 and the second frame 220 totally overlap. In other words, if the first image 212 and the second image 222 totally overlap, it indicates that the first frame 210 and the second frame 220 totally overlap.

Next, as shown in step 340, the sensing element 130 senses the second frame 220 and generates a second signal corresponding to the second frame 220, and the processing unit 140 records the second signal. The second signal is recorded, for example, by way of using the address controller 142 to record the second signal. The second signal includes the address data of the second frame 220 on the screen 200. It should be noted that, if the color of the second image 222 is the same as that of the first image 212, before the second projection apparatus 120 projects the second frame 220, the first projection apparatus 110 must be turned off first, thereby preventing the sensing errors when the sensing element 130 senses the second image 222 due to being interfered by the first image 212. Since the processing unit 140 has already recorded the address data of the first frame 210, and therefore turning off the first projection apparatus 110 does not hamper the subsequent adjusting steps.

Next, as shown in step 350, the processing unit 140 is used to control the second projection apparatus 120 according to the first signal and the second signal, so as to totally overlap the second frame 220 on the first frame 210 on the screen 200. Particularly, in step 350, for example, the address controller 142 is first used to compare whether or not the address data of the first signal is the same as that of the second signal (that is, to compare whether the address data of the first image 212 is the same as that of the second image 222). If the address data of the first signal is the same as that of the second signal, it indicates that the first frame 210 totally overlaps the second frame 220. Otherwise, if the address data of the first signal is different from that of the second signal, the signal processor 144 is used for controlling the second projection apparatus 120, so as make the address data of the first signal be the same as that of the second signal. More particularly, the signal processor 144 of this embodiment controls the driving module according to the comparison result obtained by the address controller 142, so as to adjust the focal length and position of the movable projection lens 122, and thereby change the position of the second frame 220 on the screen 200. Next, steps 330 to 350 are performed at least once until the first frame 210 totally overlaps the second frame 220 on the screen 200.

In this embodiment, the processing unit 140 is used to adjust the movable projection lens 122 of the second projection apparatus 120 according to the sensing result of the sensing element 130, so as to totally overlap the first frame 210 on the second frame 220. Since it does not require manpower for adjusting, the inaccuracy and inconveniences of the manual adjusting can be avoided, and the adjustment can be quickly and accurately completed in different environments. In addition, the first projection apparatus 110 and the second projection apparatus 120 may simultaneously project totally overlapped first frame 210 and second frame 220 on the screen 200, so as to generate a high brightness frame. The size of the overlapped frame is the same as the maximum size of the frame projected by the single projection apparatus, so that the optimal resolution and definition of the frame are maintained.

It should be noted that in the projection system 100 of this embodiment, the first projection apparatus 110 has the high color saturation and high contrast features, the second projection apparatus 120 has the high brightness feature, such that the disadvantages of the first projection apparatus 110 and the second projection apparatus 120 can be combined to make the frame projected by the projection system 100 have a high contrast, a high brightness and a high color saturation. Furthermore, the projection system 100 may be applied in the stereographic projection technology, that is, the first projection apparatus 10 and the second projection apparatus 120 respectively generate frames for being viewed by the left and right eyes of the user, so as to make the user view the stereographic frame.

### Second Embodiment

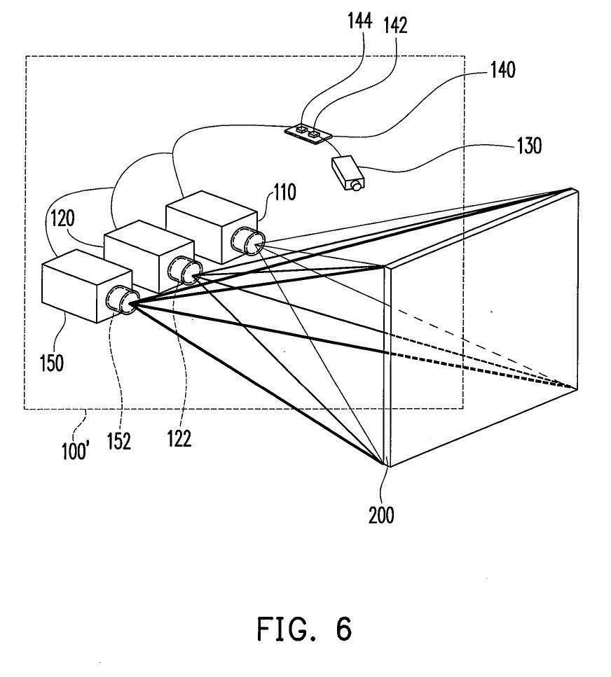

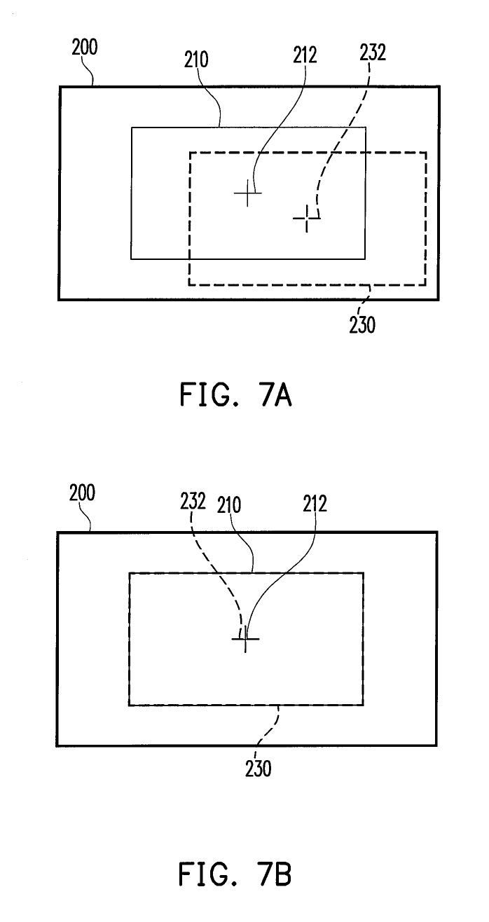

FIG. 6 is a schematic view of a projection system according to a second embodiment of the present invention, FIG. 7A is a schematic view of the imaging of the projection system of FIG. 6 before being adjusted, and FIG. 7B is a schematic view of the imaging of the projection system of FIG. 6 after being adjusted. It should be noted that in the second embodiment and the first embodiment, the same element numerals or step numerals represent the same elements or steps. Only the differences between the two embodiments are described below in detail.

Referring to FIGS. 6, 7A, and 7B, in order to further increase the brightness of the frame projected by the projection system, the projection system of the present invention includes more than two projection apparatuses. Particularly, as compared with the projection system 100, the projection system 100′ in the second embodiment further includes a third projection apparatus 150 electrically connected to the processing unit 140. The third projection apparatus 150 projects a third frame 230 on the screen 200. The sensing element 130 senses the third frame 230 on the screen 200 and generates a third signal corresponding to the third frame 230, and the third signal is transmitted to the processing unit 140. The processing unit 140 controls the third projection apparatus 150 according to the first signal and the third signal, so as to overlap the third frame 230 on the first frame 210 on the screen 200 (shown in FIG. 7B).

Accordingly, in this embodiment, the third projection apparatus 150 has a movable lens 152 and a driving module (not shown) for driving the movable projection lends 152. The address controller 142 records and compares the address data of the first signal with an address data of the third signal, and the signal processor 144 controls the third projection apparatus 150 according to the comparison result obtained by the address controller 142. More particularly, the signal processor 144 controls the driving module, so as to adjust the focal length and position of the movable projection lends 152, thereby making the third frame 230 overlap the first frame 210 on the screen 200.

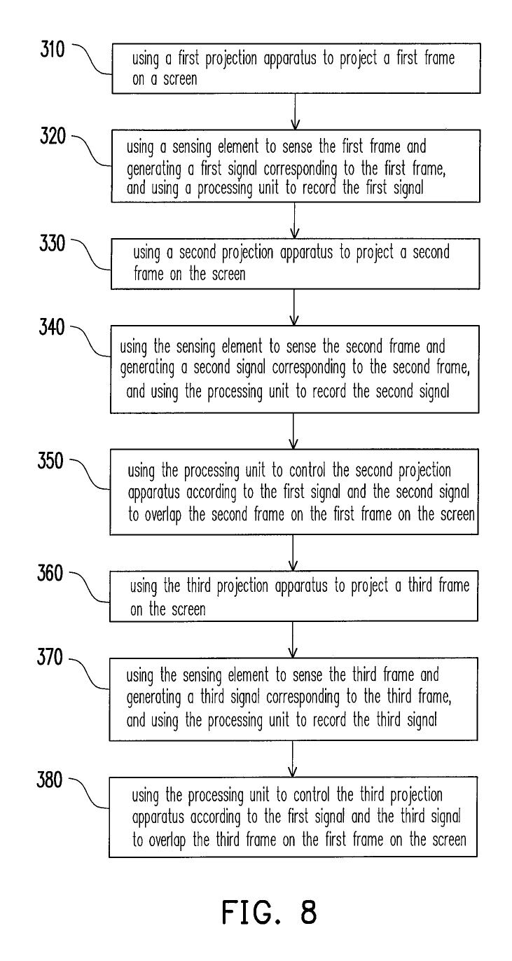

FIG. 8 is a flow chart of a method of adjusting the projection system of FIG. 3. Referring to FIGS. 6 to 8, as compared with the method of adjusting the projection system 100, the method of adjusting the projection system 100′ in the second embodiment further includes steps 360, 370, and 380. In step 360, the third projection apparatus 150 projects the third frame 230 on the screen 200. The third frame 230 has a third image 232, which is, for example, the same as the first image 212 and located in the right center of the third frame 230. The third image 232 is compared with the first image 212, so as to determine whether or not the third frame 230 and the first frame 210 totally overlap. In other words, if the first image 212 totally overlaps the third image 232, it indicates that the first frame 210 totally overlaps the third frame 230.

In step 370, the sensing element 130 senses the third frame 230 and generates a third signal corresponding to the third frame 230, and the processing unit 140 records the third signal. The third signal is recorded, for example, by way of using the address controller 142 to record the third signal. The third signal includes an address data of the third frame 230 on the screen 200. It should be noted that, if the color of the first image 212 and the second image 222 is the same as that of the third image 232, before the third projection apparatus 130 projects the third frame 230, the first projection apparatus 110 and the second projection apparatus 120 must be turned off.

In step 380, the processing unit 140 controls the third projection apparatus 150 according to the first signal and the third signal, so as to totally overlap the third frame 230 on the first frame 210 on the screen 200. Particularly, in step 380, for example, the address controller 142 is first used to compare whether or not the address data of the first signal is the same as that of the third signal (that is, to compare whether or not the address data of the first image 212 is the same as that of the third image 232). If the address data of the first signal is the same as that of the third signal, it indicates that the first frame 210 totally overlaps the third frame 230. Otherwise, if the address data of the first signal is different from that of the third signal, the signal processor 144 controls the third projection apparatus 150 to make the address of the first signal be the same as that of the third signal. More particularly, the signal processor 144 of this embodiment controls the driving module according to the comparing result obtained by the address controller 142, so as to adjust the focal length and position of the movable projection lens 152, and thereby changing the position of the third frame 230 on the screen 200. Next, steps 360-380 are performed at least once until the first frame 210 totally overlaps the third frame 230 on the screen 200.

The projection system 100′ has three projection apparatuses, so frames with higher brightness than those projected by the projection system 100 are projected. In the second embodiment, although three projection apparatuses are illustrated as an example, the projection system of the present invention may include more than three projection apparatuses. In addition, when the projection system has more than three projection apparatuses, the first three projection apparatuses are adjusted according to the adjusting method of the first and the second embodiments, the other projection apparatuses are sequentially adjusted through the method of adjusting the third projection apparatus 150 in the second embodiment.

To sum up, the present invention at least has one or more of the following advantages.

First, the projection system of the present invention automatically achieves the adjusting process without requiring any manual operation, and therefore the adjustment can be implemented quickly and accurately.

Second, the frames totally overlap, and the size of the overlapped frame is the same as the maximum size of the frame projected by the single projection apparatus, so that the optimal resolution of the frame is maintained.

Third, a plurality of projection apparatuses is used to multiply the frame brightness without adversely affecting other optical performances.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection system, comprising:
a first projection apparatus, for projecting a first frame on a screen;
a second projection apparatus, for projecting a second frame on the screen;
a sensing element, for sensing the first frame and the second frame on the screen, and generating a first signal corresponding to the first frame and a second signal corresponding to the second frame; and
a processing unit, electrically connected to the first projection apparatus, the second projection apparatus and the sensing element, for receiving the first signal and the second signal and controlling the second projection apparatus according to the first signal and the second signal to overlap the second frame on the first frame on the screen.

2. The projection system as claimed in claim 1, wherein the sensing element is a charge-coupled device (CCD) or a complementary metal-oxide semiconductor (CMOS) image sensor.

3. The projection system as claimed in claim 1, wherein the processing unit comprises:
an address controller, for recording and comparing an address data of the first signal with an address data of the second signal; and
a signal processor, electrically connected to the address controller, for controlling the second projection apparatus according to a comparison result obtained by the address controller to overlap the second frame on the first frame on the screen.

4. The projection system as claimed in claim 3, wherein the second projection apparatus has a movable projection lens and a driving module for driving the movable projection lens, and the signal processor is used for controlling the driving module to adjust a focal length and position of the movable projection lens.

5. The projection system as claimed in claim 1, further comprising a third projection apparatus electrically connected to the processing unit, wherein the third projection apparatus is used for projecting a third frame on the screen, the sensing element is used for sensing the third frame on the screen and generating a third signal corresponding to the third frame and transmit the third signal to the processing unit, and the processing unit is used for controlling the third projection apparatus according to the first signal and the third signal to overlap the third frame on the first frame on the screen.

6. The projection system as claimed in claim 1, wherein the processing unit is disposed within one of the first projection apparatus and the second projection apparatus.

7. The projection system as claimed in claim 1, further comprising a fixing apparatus, wherein the first projection apparatus and the second projection apparatus are fixed by the fixing apparatus.

8. A method of adjusting a projection system, comprising:
(a) using a first projection apparatus to project a first frame on a screen;
(b) using a sensing element to sense the first frame and generating a first signal corresponding to the first frame, and using a processing unit to record the first signal;
(c) using a second projection apparatus to project a second frame on the screen;
(d) using the sensing element to sense the second frame and generating a second signal corresponding to the second frame, and using the processing unit to record the second signal; and
(e) using the processing unit to control the second projection apparatus according to the first signal and the second signal to overlap the second frame on the first frame on the screen.

9. The method as claimed in claim 8, wherein the processing unit comprises an address controller and a signal processor electrically connected to the address controller, and the address controller records the first signal in the step (b) and the address controller records the second signal in the step (d).

10. The method as claimed in claim 9, wherein the step (e) comprises:
using the address controller to compare whether or not an address data of the first signal and an address data of the second signal are the same; and
using the signal processor to control the second projection apparatus when the address data of the first signal is different from the address data of the second signal to make an address of the first signal be the same as an address of the second signal.

11. The method as claimed in claim 10, wherein the second projection apparatus has a movable projection lens and a driving module for driving the movable projection lens, and the step (e) comprises controlling the driving module by the signal processor to adjust a focal length and position of the movable projection lens.

12. The method as claimed in claim 11, further comprising performing step (c) to (e) at least once after the step of adjusting the focal length and position of the movable projection lens until the second frame overlaps the first frame on the screen.

13. The method as claimed in claim 8, wherein the projection system further comprises a third projection apparatus, and the method of adjusting the projection system further comprises:
(f) using the third projection apparatus to project a third frame on the screen;
(g) using the sensing element to sense the third frame and generating a third signal corresponding to the third frame, and using the processing unit to record the third signal; and
(h) using the processing unit to control the third projection apparatus according to the first signal and the third signal to overlap the third frame on the first frame on the screen.
